(19) United States
(12) Patent Application Publication
(10) Pub. No.: US 2011/0148599 A1
(43) Pub. Date: Jun. 23, 2011

(54) RFID READER, RFID TAG, AND METHOD OF RECOGNIZING PLURALITY OF RFID TAGS

(75) Inventors: Chan Won Park, Daejeon (KR); Man Sik Park, Daejeon (KR); Ji Hoon Bae, Daejeon (KR); Dong Han Lee, Daejeon (KR); Kwang Soo Cho, Daejeon (KR); Won Kyu Choi, Daejeon (KR); Cheng Hao Quan, Daejeon (KR); Jeong Seok Kim, Daejeon (KR); Gil Young Choi, Daejeon (KR); Jong Suk Chae, Daejeon (KR)

(73) Assignee: Electronics and Telecommunications Research Institute, Daejeon (KR)

(21) Appl. No.: 12/913,347

(22) Filed: Oct. 27, 2010

(30) Foreign Application Priority Data
Dec. 21, 2009 (KR) 10-2009-0127669

(51) Int. Cl. H04Q 5/22

(52) U.S. Cl. 340/10.32; 340/10.51

(57) ABSTRACT

The RFID reader of an RFID system includes a processor for processing a command for the RFID tag and a response from the RFID tag, a modem for modulating the command from the processor or demodulating the response from the RFID, and an RF unit for transmitting the modulated command transferred from the modem to the RFID tag or receiving the response from the RFID tag and transferring the response to the modem. The RFID tag of the RFID system includes a power supply unit for generating energy using a radio wave received from the RFID reader, a receiver for demodulating a signal received from the RFID reader, a data processor for performing operation according to the signal demodulated by the receiver, and a transmitter for backscattering a signal from the data processor.

### CROSS-REFERENCE TO RELATED APPLICATION

This application claims priority to and the benefit of Korean Patent Application No. 10-2009-0127669, filed Dec. 21, 2009, the disclosure of which is incorporated herein by reference in its entirety.

### BACKGROUND

1. Field of the Invention

The present invention relates to a radio frequency identification (RFID) reader, an RFID tag, and a method of recognizing a plurality of RFID tags, and more particularly to an RFID system and method which controls a protocol and operation between an RFID reader and a plurality of RFID tags to easily recognize the RFID tags while reducing as much collision among the RFID tags as possible.

2. Discussion of Related Art

In general, RFID technology enables information to be read from or recorded in a tag having unique ID information using an RF without contact, so that an animal, person, etc. to which a tag is attached can be recognized, tracked, and managed. An RFID system includes a plurality of RFID tags (electronic tag or transponder; also referred to as tags below) and an RFID reader (interrogator; also referred to as a reader below) for reading or writing information that the tags have.

When the reader sends a command to all the tags in the RFID system according to conventional art, all the tags select random slots and respond to the command according to RFID tag recognition technology. At this time, collisions occur when many tags select the same slot, and backscattering of all the tags interferes with adjacent tags. As a result, tag recognition time increases, or the number of recognizable tags is limited.

### SUMMARY OF THE INVENTION

The present invention is directed to a radio frequency identification (RFID) system and method that reduce collisions among responses of a plurality of tags using a tag grouping scheme and an inter-tag interference removing scheme in addition to a conventional general tag protocol, and thus can increase the number of recognizable tags to several times that of conventional art.

One aspect of the present invention provides an RFID reader of an RFID system including: a processor for processing a command for an RFID tag and a response from the RFID tag; a modem for modulating the command from the processor or demodulating the response from the RFID; an RF unit for transmitting the modulated command transferred from the modem to the RFID tag, or receiving the response from the RFID tag and transferring the response to the modem; and a memory for storing a tag ID of the RFID tag read by the processor and managing recognized tag IDs according to groups.

Another aspect of the present invention provides an RFID tag of an RFID system including: a power supply unit for generating energy using a radio wave received from an RFID reader; a receiver for demodulating a signal received from the RFID reader; a data processor for performing operation according to the signal demodulated by the receiver; and a transmitter for backscattering a signal from the data processor. Here, the data processor of the RFID tag includes: a protocol processor for performing operation according to a command of the RFID reader; a transmission controller for controlling a backscattering function of the transmitter; and a group selector for selecting a group number of the RFID tag.

Still another aspect of the present invention provides a method of recognizing a plurality of RFID tags in an RFID system including: transmitting, at an RFID reader, a group_select command to at least one of the RFID tags; selecting, at the RFID tag, a group number of the RFID tag on the basis of the group_select command; transmitting, at the RFID reader, a wake_group command including an argument specifying a group number to the RFID tag; determining, at the RFID tag, whether or not the group number specified by the wake_group command and the group number of the RFID tag are identical; and disabling a backscattering function of the RFID tag when the specified group number and the group number of the RFID tag are not identical, and enabling the backscattering function of the RFID tag when the specified group number and the group number of the RFID tag are identical.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a radio frequency identification (RFID) system, schematically illustrating a method for an RFID reader to recognize a plurality of tags;

FIG. 2 shows examples of commands and responses exchanged between a reader and tags while the reader performs an inventory round process according to an electronic product code (EPC) class 1 (C1) generation 2 (G2) standard;

FIG. 3 is a schematic block diagram of an RFID reader and an RFID tag in an RFID system according to an exemplary embodiment of the present invention;

FIG. 4 illustrates communication and operation performed between an RFID reader and a plurality of RFID tags in an RFID system according to an exemplary embodiment of the present invention;

FIG. 5 shows an example of command flow between a reader and tags in an RFID system according to an exemplary embodiment of the present invention;

FIG. 6 is a flowchart schematically illustrating operation of a reader in an RFID system according to an exemplary embodiment of the present invention;

FIG. 7 is a flowchart illustrating operation of a tag in an RFID system according to an exemplary embodiment of the present invention; and

FIG. 8 is a flowchart illustrating a method of recognizing a plurality of RFID tags according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Throughout this specification, when an element is referred to as being “connected” or “coupled” to another element, it can be directly connected or coupled to the other element or electrically connected or coupled to the other element with yet another element interposed between them.

Throughout this specification, when an element is referred to as “comprises,” “includes,” or “has” a component, it does not preclude another component but may further include the other component unless the context clearly indicates otherwise. Also, as used herein, the terms “. . . unit,” “. . . device,” “. . . module,” etc., denote a unit of processing at least one function or operation, and may be implemented as hardware, software, or combination of hardware and software.

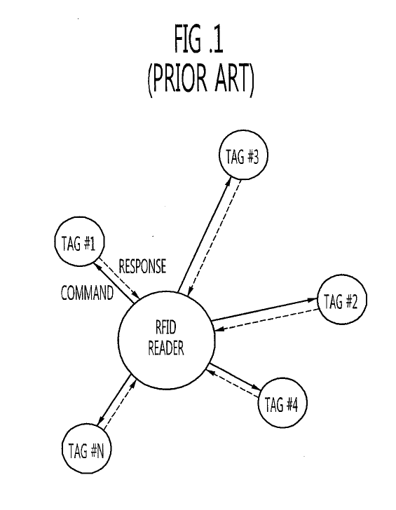

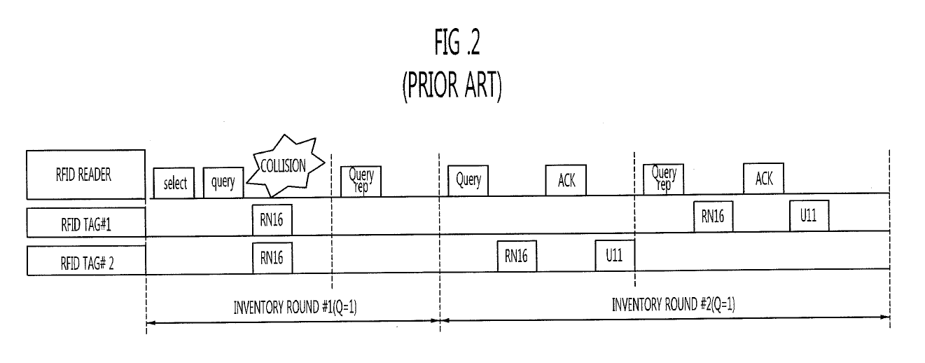

FIG. 1 is a block diagram of a radio frequency identification (RFID) system, schematically illustrating a method for an RFID reader to recognize a plurality of tags tag#1, tag#2, tag#3, tag#4, . . . , and tag#N. FIG. 2 shows examples of commands and responses exchanged between a reader and tags while the reader performs an inventory round process when a Q value is 1 in an electronic product code (EPC) class 1 (C1) generation 2 (G2 or Gen2) standard.

Referring to FIGS. 1 and 2, in an RFID system according to conventional art, a reader performs inventory processes for a plurality of tags at the same time. When the reader recognizes several hundred tags or so, a tag recognition time increases due to a long inventory and retransmission process, and the number of recognizable tags is limited.

An RFID system and method according to an exemplary embodiment of the present invention will be described in detail below with the appended drawings.

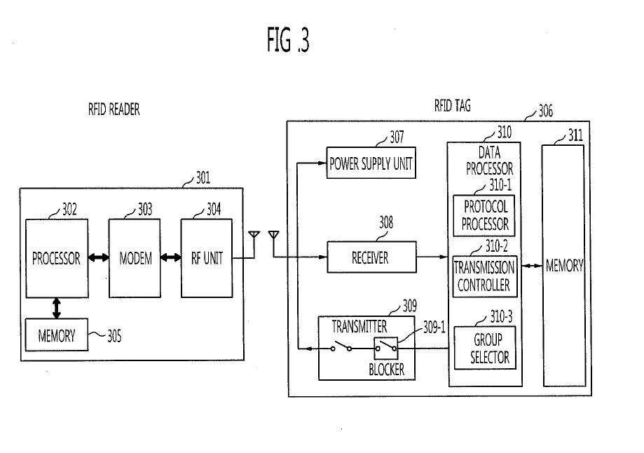

FIG. 3 is a schematic block diagram of an RFID reader 301 and an RFID tag 306 in an RFID system according to an exemplary embodiment of the present invention. Although one RFID reader and one RFID tag are shown in FIG. 3, those of ordinary skill in the art will appreciate that a plurality of readers and a plurality of tags may be included in the RFID system.

The RFID reader 301 includes a processor 302, a modem 303, an RF unit 304, and a memory 305. The processor 302 processes a command for the RFID tag 306, which is within a predetermined range of the RFID reader 301, and a response from the RFID tag 306. The modem 303 modulates the command from the processor 302 and transfers the modulated command to the RF unit 304, or demodulates a signal received from the RF unit 304 and transfers the demodulated signal to the processor 302. In an exemplary embodiment of the present invention, the modem 303 may include an encoder/decoder (not shown) to encode/decode a signal. The RF unit 304 receives the signal obtained by modulating the command of the processor 302 from the modem and transmits the signal to the outside, or receives an external signal from the RFID tag and transfers the received external signal to the modem 303. The memory 305 stores a tag ID read by the processor 302 and manages recognized tag IDs according to groups.

The RFID tag 306 includes a power supply unit 307, a receiver 308, a transmitter 309, a data processor 310, and a memory 311. The power supply unit 307 receives a radio wave from the RFID reader 301 through an antenna, generates and keeps a direct current (DC) voltage at a fixed level, and supplies power to the components of the RFID tag 306. The receiver 308 demodulates a signal received from the RFID reader 301 through the antenna and transfers the demodulated signal to the data processor 310. The receiver 308 may include a decoder and decode the signal received through the antenna. The data processor 310 includes a protocol processor 310-1 processing data according to a command (e.g., a search command, a read/record command, and a wake_group command) transmitted from the RFID reader 301, a transmission controller 310-2 controlling the backscattering function of the transmitter 309, and a group selector 310-3 selecting a group number according to a command (e.g., a group_select command) transmitted from the RFID reader 301. In an exemplary embodiment of the present invention, the group number may be a random integer. The transmitter 309 backscatters response data processed by the data processor 310. The transmitter 309 includes a blocker 309-1 controlling the backscattering operation of the transmitter 309, and the blocker 309-1 is configured to operate according to a control of the transmission controller 310-2. In an exemplary embodiment, the blocker 309-1 may cut off the power supply connection of the transmitter 309, the antenna connection, or both of the power supply connection and the antenna connection. The memory 311 stores data processed by the data processor 310, and may be a non-volatile memory in an exemplary embodiment of the present invention.

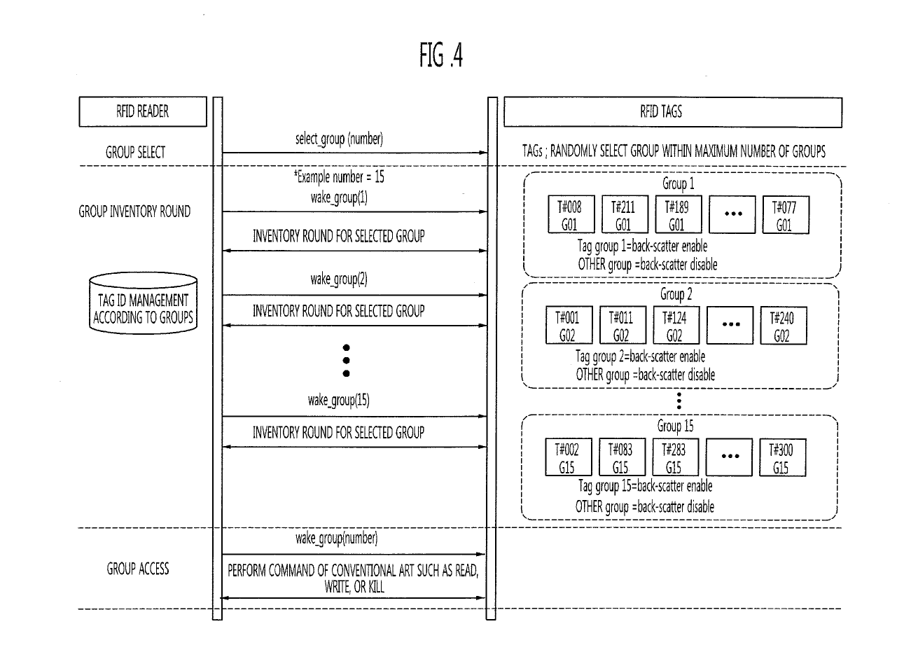

FIG. 4 illustrates communication and operation performed between an RFID reader and a plurality of RFID tags in an RFID system according to an exemplary embodiment of the present invention. Operation between a reader and tags is divided into a “group select” section, a “group inventory round” section, and a “group access” section. In the group select section, tags are classified according to groups. In the group inventory round section, tags are read using conventional inventory round technology according to groups. In the group access section, a group to which a desired tag belongs is selected to perform a command, such as a read, write, kill, or lock command, on the tag, and an access operation is performed on the tag belonging to the selected group. These sections will be described in further detail below with reference to FIG. 4.

In the group select section, a reader transmits a “group_select(number)” command (also referred to as a “group_select command”) to tags within a predetermined range. Here, the number can denote the maximum number of tag groups, and tags randomly select a group number within the maximum number of tag groups. For example, when the reader transmits a “group_select(3)” command, there can be 3 tag groups(e.g. a group 1, a group 2, and a group 3), and tags can select one of the group 1 to 3. Furthermore, when the reader transmits a “group_select(0)” command, all the tags can select a group 0, and only one group is formed. The following operation conforms to the conventional inventory round rule of EPC C1 Gen2. In an exemplary embodiment of the present invention, the default group of tags is 0. The tags belonging to the group 0 can operate according to the conventional EPC C 1 Gen2 standard, and thus is compatible with conventional technology.

When the reader transmits a “group_select(15)” command in the example shown in FIG. 4, tags select an integer from a range of 1 to 15. In other words, each tag belongs to a group indicated by an integer (e.g., a group 1, a group 2, . . . , or a group 15).

In the inventory round section, the reader transmits a “wake_group(number)” command (also referred to as a “wake_group command”) to select a specific tag group. Here, the number denotes a group number which is equal to or smaller than the maximum number indicated by the group_select command. Every time the reader transmits the wake_group command, the number may increase from 1, or the number may be randomly selected. A tag receiving the wake_group command from the reader determines whether the group number indicated by the wake_group command is identical to a group number selected by the tag itself. When the selected group number is identical to the group number indicated by the wake_group command, the tag is placed into a state in which it is possible to use the backscattering function of the transmitter of the tag and thus can communicate with the reader according to the inventory round rule. On the other hand, when the selected group number is not identical to the group number indicated by the wake_group command, the tag disables the backscattering function of the transmitter and keeps the backscattering function disabled until a wake_group command indicating the same group number as selected by the tag itself is received. When a wake_group command indicating the same group number as selected by the tag itself is received, the tag enables the backscattering function and can communicate with the reader according to the inventory round rule. The reader transmits wake_group commands to all groups corresponding to the number indicated by the group_select command and performs the inventory round process, thereby storing tag IDs according to the groups.

In the group access section, the reader may access a specific tag on the basis of the stored tag IDs. When the reader transmits a wake_group command to select a group to which the specific tag belongs, the backscattering function of tags belonging to groups other than a group having a group number indicated by the wake_group command is disabled, and an access operation to the specific tag belonging to the group enabled to use the backscattering function can be performed according to conventional art.

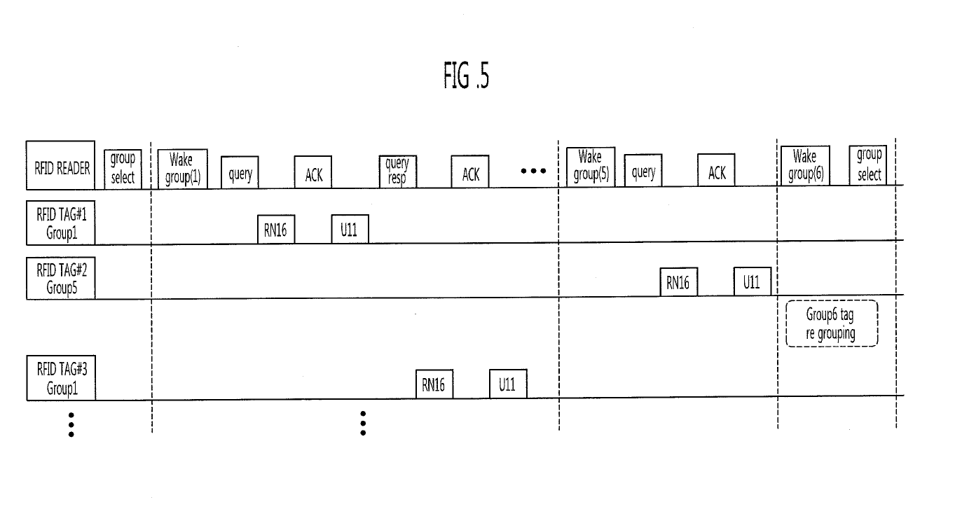

FIG. 5 shows an example of command flow between a reader and tags in an RFID system according to an exemplary embodiment of the present invention. When the reader transmits a group_select command to tags, each tag selects a group. In FIG. 5, tag#1 selects a group 1, tag#2 selects a group 5, and tag#3 selects the group 1. When the reader selects the group 1 for a wake_group command, the backscattering function of tag#1 and tag#3 belonging to the group 1 is enabled, and that of tags belonging to other groups is disabled. Subsequently, the reader sends a query according to the conventional inventory round rule, and then reads tag#1 and tag#3 belonging to the group 1. After this, when the reader selects the group 5 for a wake_group command, the backscattering function of tag#2 alone belonging to the group 5 is enabled, and that of tags belonging to other groups is disabled. Subsequently, the reader sends a query according to the inventory round rule, and then reads only tag#2 belonging to the group 5.

In an exemplary embodiment of the present invention, it is possible to select a specific group using a wake_group command and command tags belonging to the selected group to select a group again. In FIG. 5, the reader transmits a “wake_group(6)” command to select tags of a group 6, and then regroups the tags of the group 6 using a group_select command. This is intended to uniformly distribute tags to groups when many tags belong to a specific group. When a group_select command for tags belonging to a specific group is transmitted, the maximum group number can be indicated by an argument of the group_select command, and also first and final group numbers may be indicated so that the tags can select a new group within a specific range. For example, when a “group_select(2, 4)” command is transmitted to the tags of the group 6, each tag belonging to the group 6 selects one of a group 2, a group 3, and a group 4.

FIG. 6 is a flowchart schematically illustrating operation of a reader in an RFID system according to an exemplary embodiment of the present invention. A reader may transmit a group_select command to tags within a predetermined range. After transmitting the group_select command, the reader may transmit a wake_group command to the tags and perform an inventory round process together with tags belonging to a specific group. The reader may collect IDs of tags according to the inventory round rule and manage the tag IDs according to groups. The reader may perform an access process to a specific tag on the basis of the collected/managed tag IDs. Before or after the access process, the reader may transmit another wake_group command to the tags. Also, as described above, the reader may retransmit a group_select command to tags grouped by the group_select command, thereby regrouping tags of a specific group.

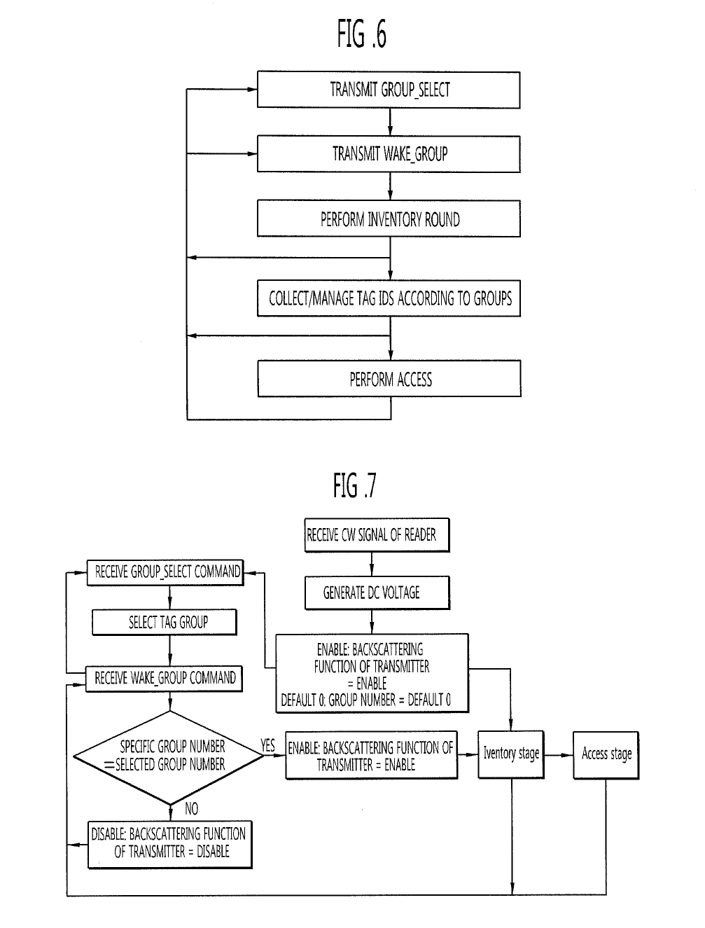

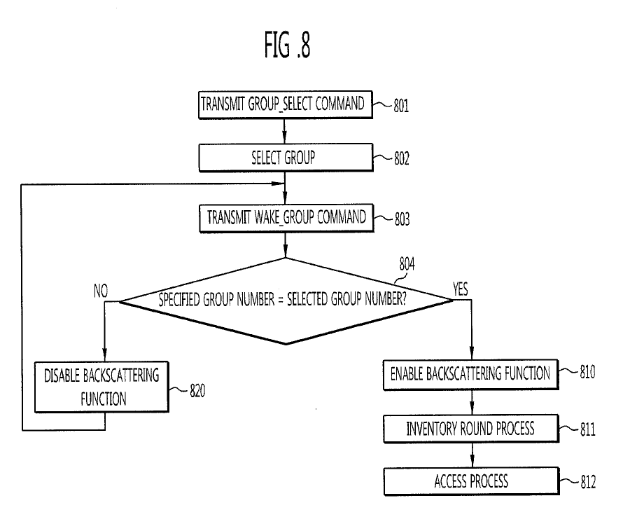

FIG. 7 is a flowchart illustrating operation of a tag in an RFID system according to an exemplary embodiment of the present invention. When a continuous wave (CW) signal is received from a reader, a tag generates a DC voltage, enables the backscattering function of a transmitter, and selects the group number of the tag itself as a default value (e.g., the group number=0). After this, the tag can communicate with the reader according to the conventional inventory round rule. For example, the tag can provide a response corresponding to a command of the reader and a tag ID.

When a group_select command is received from the reader, the tag selects and stores its group number. As described above, when a group_select command is received again from the reader, the tag may reselect its group number on the basis of, for example, an argument for a group number indicated by the reader in the group_select command according to the received group_select command. After this, when a wake_group command is received from the reader, the tag compares the group number selected by the tag itself with a group number specified by the wake_group command. When the selected group number differs from the specified group number, the tag disables the backscattering function of the transmitter, and waits until another wake_group command is received. On the other hand, when the selected group number is identical to the specified group number, the tag enables the backscattering function of the transmitter. Thus, the tag can communicate with the reader according to the conventional inventory round rule. Also, the tag performs an access process together with the reader and waits until a wake_group command is received again from the reader. After a wake_group command is received, the tag may receive a group_select command again, or reselect its group number on the basis of the group_select command.

FIG. 8. is a flowchart illustrating a method of recognizing a plurality of RFID tags according to an exemplary embodiment of the present invention. An RFID tag recognition method according to an exemplary embodiment of the present invention will be described in detail below with reference to FIGS. 3 to 8.

The RFID reader 301 transmits a group_select command to a plurality of RFID tags (step 801). The group_select command includes an argument indicating the maximum number of groups or the range of groups.

Each RFID tag receiving the group_select command selects a group number (step 802). The group selector 310-3 of the RFID tag 306 randomly selects a group number on the basis of the argument indicated by the group_select command and stores the selected group number. In an exemplary embodiment of the present invention, the group selector 310-3 may select a group number using a random number generator (not shown), and the selected group number may be stored in the memory 311.

The reader 301 transmits a wake_group command to the RFID tags (step 803). The wake_group command includes an argument specifying a group number.

Each RFID tag receiving the wake_group command determines whether or not the group number specified by the wake_group command is identical to a group number selected by the RFID tag itself (step 804). The protocol processor 310-1 of the RFID tag 306 compares the group number stored in the memory 311 with the group number specified by the wake_group command received from the RFID reader 301.

When the group number specified by the wake_group command and the group number selected by the RFID tag 306 are identical, the backscattering function of the RFID tag 306 is enabled (step 810). The transmission controller 310-2 of the RFID tag 306 controls the blocker 309-1 of the transmitter 309 not to operate, thereby maintaining the backscattering function of the transmitter 309. Since the backscattering function of the RFID tag 306 is maintained, the RFID reader 301 and the RFID tag 306 can perform an inventory round process (step 811). Also, an access process to the RFID tag 306 may be performed (step 812).

Meanwhile, when the group number specified by the wake_group command and the group number selected by the RFID tag 306 are not identical to each other, the backscattering function of the RFID tag 306 is disabled (step 820). The transmission controller 310-2 of the RFID tag 306 controls the blocker 309-1 of the transmitter 309 to operate, thereby disabling the backscattering function of the transmitter 309. The blocker 309-1 may be implemented by a switch. The switch may be switched to a connection state or a disconnection state according to a control signal of the transmission controller 310-2, thereby cutting off the power supply of the transmitter 309 or a connection between the transmitter 309 and the antenna. The RFID tag 306 whose backscattering function is disabled waits until a wake_group command is transmitted again, and the process returns to step 804 when a wake_group command is transmitted.

When a plurality of RFID tags piled up and overlapping each other receive a command from a reader, mutual coupling occurs between the tags due to antennas and the backscattering function and slightly interferes with a signal of neighboring tags. According to an exemplary embodiment of the present invention, the backscattering function of an RFID tag belonging to no group is completely disabled in advance, and thus the number of tags between which mutual coupling occurs is reduced. Consequently, interference between tags is reduced, and tag recognition performance is enhanced.

As described above, an RFID system and method according to an exemplary embodiment of the present invention can process several thousand tags or more as it would dozens of tags and thus can easily recognize a plurality of tags.

Also, since the RFID system and method disable the backscattering function of tags belonging to a non-selected group, mutual coupling between tags is reduced, and a recognition rate can be increased even if tags overlap each other. In particular, when a high frequency (HF) Gen2 protocol, such as International Organization for Standardization (ISO)/International Electrotechnical Commission (IEC) 18000-3 mode 3, is applied to the RFID system and method, it is possible to exceptionally improve the multiple tag recognition performance of an HF tag in comparison with other technology.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A radio frequency identification (RFID) reader, comprising:
a processor for processing a command for an RFID tag and a response from the RFID tag;
a modem for modulating the command from the processor or demodulating the response from the RFID;
an RF unit for transmitting the modulated command transferred from the mode to the RFID tag, or receiving the response from the RFID tag and transferring the response to the modem; and
a memory for storing a tag ID of the RFID tag read by the processor and managing recognized tag IDs according to groups.

2. The RFID reader of claim 1, wherein the RFID reader transmits a group_select command commanding the RFID tag to select a group number of the RFID tag itself to the RFID tag.

3. The RFID reader of claim 2, wherein the group_select command includes an argument indicating a maximum or a range of the group number of the RFID tag.

4. The RFID reader of claim 1, wherein the RFID reader transmits a wake_group command including an argument specifying a group number to the RFID tag.

5. A radio frequency identification (RFID) tag, comprising:
a power supply unit for receiving a radio wave from an RFID reader and generating a voltage;
a receiver for demodulating a signal received from the RFID reader;
a data processor for processing the signal demodulated by the receiver; and
a transmitter for backscattering a signal from the data processor,
wherein the data processor includes:
a protocol processor for performing operation according to a command of the RFID reader;
a transmission controller for controlling a backscattering function of the transmitter; and
a group selector for selecting a group number of the RFID tag.

6. The RFID tag of claim 5, further comprising a memory for storing the group number selected by the group selector.

7. The RFID tag of claim 5, wherein the group selector selects the group number of the RFID tag on the basis of a group_select command transmitted from the RFID reader.

8. The RFID tag of claim 7, wherein the group_select command includes an argument indicating a maximum or a range of the group number of the RFID tag.

9. The RFID tag of claim 5, wherein the transmitter includes a blocker for cutting off a power supply connection of the transmitter or an antenna connection of the transmitter.

10. The RFID tag of claim 9, wherein the blocker operates according to a control signal of the transmission controller.

11. The RFID tag of claim 5, wherein the group selector includes a random number generator, and
the group number of the RFID tag is selected using the random number generator.

12. The RFID tag of claim 5, wherein the RFID reader transmits a wake_group command including an argument specifying a group number to the RFID tag, and
the RFID tag determines whether or not the group number specified by the wake_group command and the group number of the RFID tag are identical.

13. The RFID tag of claim 12, wherein when the specified group number and the group number of the RFID tag are identical, the transmission controller enables a backscattering function of the transmitter.

14. The RFID tag of claim 12, wherein when the specified group number and the group number of the RFID tag are not identical, the transmission controller disables a backscattering function of the transmitter.

15. A method of recognizing a plurality of radio frequency identification (RFID) tags, comprising:
transmitting a group_select command to at least one of the RFID tags, the group_select command results in the RFID tag to select a group number of the RFID tag itself to the RFID tag;
transmitting a wake_group command including an argument specifying a group number to the RFID tag; and
performing an inventory round process together with the RFID tag belonging to a specific group of the RFID tags.

16. The method of claim 15, further comprising retransmitting a group_select command to the RFID tags grouped by the group_select command.

17. A method of recognizing a plurality of radio frequency identification (RFID) tags, comprising:
receiving a group_select command from an RFID reader and selecting a group number of the RFID tag on the basis of the group_select command;
receiving a wake_group command including an argument specifying a group number to the RFID tag;
determining whether or not the group number specified by the wake_group command and the group number of the RFID tag are identical; and
disabling a backscattering function of the RFID tag when the specified group number and the group number of the RFID tag are not identical, and enabling the backscattering function of the RFID tag when the specified group number and the group number of the RFID tag are identical.

18. The method of claim 17, further comprising reselecting the group number of the RFID tag on the basis of a retransmitted group_select command.

19. The method of claim 17, wherein the group_select command includes an argument indicating a maximum or a range of the group number of the RFID tag.

20. The method of claim 19, wherein the group number of the RFID tag is randomly selected on the basis of the argument.
